(19) United States
(12) Patent Application Publication
(10) Pub. No.: US 2013/0021132 A1
(43) Pub. Date: Jan. 24, 2013

(54) PERMANENT ONE-SHOT THERMOSTAT

(71) Applicants: Senthilkumar Mettuppalayam Kandhasamy, Bangalore (IN); Colin Drummond, Motherwell (GB)

(72) Inventors: Senthilkumar Mettuppalayam Kandhasamy, Bangalore (IN); Colin Drummond, Motherwell (GB)

(73) Assignee: HONEYWELL INTERNATIONAL INC., Morristown, NJ (US)

(21) Appl. No.: 13/188,133

(22) Filed: Jul. 21, 2011

(51) Int. Cl. H01H 37/52

(52) U.S. Cl. 337/333; 337/298

(57) ABSTRACT

A one-shot thermostat includes a temperature sensitive element that is responsive to temperature to move from a first position to a second position when its temperature increases above a first temperature, and from the second position back to the first position when its temperature decreases below a second temperature. A switch moves from a first switch position to a second switch position when the temperature sensitive element moves from the first position to the second position. A spring element is configured to supply a retainer force to the switch when the temperature sensitive element moves from the first position to the second position that retains the switch in the second switch position when the temperature sensitive element moves from the second position back to the first position.

### TECHNICAL FIELD

The present invention generally relates to thermostats, and more particularly relates to a permanent one-shot thermostat in which switch contacts, once opened, remain in an open position.

### BACKGROUND

Many thermostats include a temperature sensitive element, such as a bimetallic element, that switches from one stable position to another stable position in response to temperature variations. In one particular type of thermostat, which is typically referred to as a “one-shot thermostat,” the temperature sensitive element is preferably configured to switch (or “snap”) from a first position to a second position when its temperature increases above a temperature set value, and then remain in the second position even if (or when) its temperature subsequently decreases. In many instances, the temperature sensitive element operates, either directly or indirectly, a switch element. The switch element in turn causes an external device to be either energized or de-energized, depending upon the configuration of the switch.

In some implementations, a one-shot thermostat may be subjected to relatively low temperatures after the temperature sensitive element has snapped to the second position. Depending upon the particular composition of the temperature sensitive element, if the temperature reaches a sufficiently low temperature, the temperature sensitive element may undesirably snap back to the first position. As a result, the switch element may in turn undesirably cause the external device to be de-energized or re-energized, as the case may be.

Hence, there is a need for a one-shot thermostat that can be implemented with a presently known bimetallic element, and that will not automatically reset at a relatively low temperature value. The present invention addresses at least this need.

### BRIEF SUMMARY

In one embodiment, a one-shot thermostat includes a housing, a temperature sensitive element, a switch, and a spring element. The temperature sensitive element is mounted within the housing and is responsive to temperature to selectively move from a first position to a second position when the temperature of the temperature sensitive element increases above a first predetermined temperature and to move from the second position back to the first position when the temperature of the temperature sensitive element decreases below a second predetermined temperature. The switch is mounted within the housing and is movable between a first switch position and a second switch position. The switch is configured, upon movement of the temperature sensitive element from the first position to the second position, to move from the first switch position to the second switch position. The spring element is mounted within the housing and is in contact with the temperature sensitive element. The spring element is disposed between the temperature sensitive element and the switch and is configured to supply a retainer force to the switch when the temperature sensitive element moves from the first position to the second position. The retainer force retains the switch in the second switch position when the temperature sensitive element moves from the second position back to the first position.

In another embodiment, a one-shot thermostat includes a housing, a switch, a temperature sensitive element, a spring disc, and a transfer pin. The switch is disposed within the housing and is movable between a first switch position and a second switch position. The temperature sensitive element is disposed within the housing and is responsive to temperature. The temperature sensitive element is configured to move from a first position to a second position when the temperature of the temperature sensitive element increases above a first predetermined temperature and to move from the second position back to the first position when the temperature of the temperature sensitive element decreases below a second predetermined temperature. The spring disc is mounted within the housing in contact with the temperature sensitive element, and is disposed between the temperature sensitive element and the switch. The spring disc is configured to supply a retainer force to the switch when the temperature sensitive element moves from the first position to the second position. The retainer force retains the switch in the second switch position when the temperature sensitive element moves from the second position back to the first position. The transfer pin is disposed between the switch and the spring disc, and is configured, upon movement of the temperature sensitive element from the first position to the second position, to move the switch from the first switch position to the second switch position.

In yet another embodiment, a one-shot thermostat includes a housing, a switch, a bimetallic disc, a transfer pin, and a spring disc. The switch is disposed within the housing and is movable between a first switch position and a second switch position. The bimetallic disc is disposed within the housing and responsive to temperature. The bimetallic disc is configured to move from a first position to a second position when the temperature of the bimetallic disc increases above a first predetermined temperature and to move from the second position back to the first position when the temperature of the bimetallic disc decreases below a second predetermined temperature. The transfer pin is disposed adjacent the switch and is configured, upon movement of the bimetallic disc from the first position to the second position, to move the switch from the first switch position to the second switch position. The spring disc is mounted within the housing in contact with the temperature sensitive element, and is disposed between the temperature sensitive element and the transfer pin. The spring disc is configured to move from a non-retaining position to a retaining position when the bimetallic disc moves from the first position to the second position and remain in the retaining position when the temperature sensitive element moves from the second position back to the first position. The spring disc supplies a retainer force to the transfer pin that retains the switch in the second switch position when the bimetallic disc moves from the second position back to the first position.

Furthermore, other desirable features and characteristics of the one-shot thermostat will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIGS. 1 and 2 depicts a cross section view of an embodiment of a one-shot thermostat in a first state;

FIGS. 3 and 4 depict the cross section view of the one-shot thermostat of FIGS. 1 and 2 with the thermostat in a second state; and

FIGS. 5 and 6 depict the cross section view of the one-shot thermostat of FIGS. 1 and 2 with the thermostat in a third state.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Moreover, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements. Moreover, two elements may simply contact each other.

Moreover, all of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

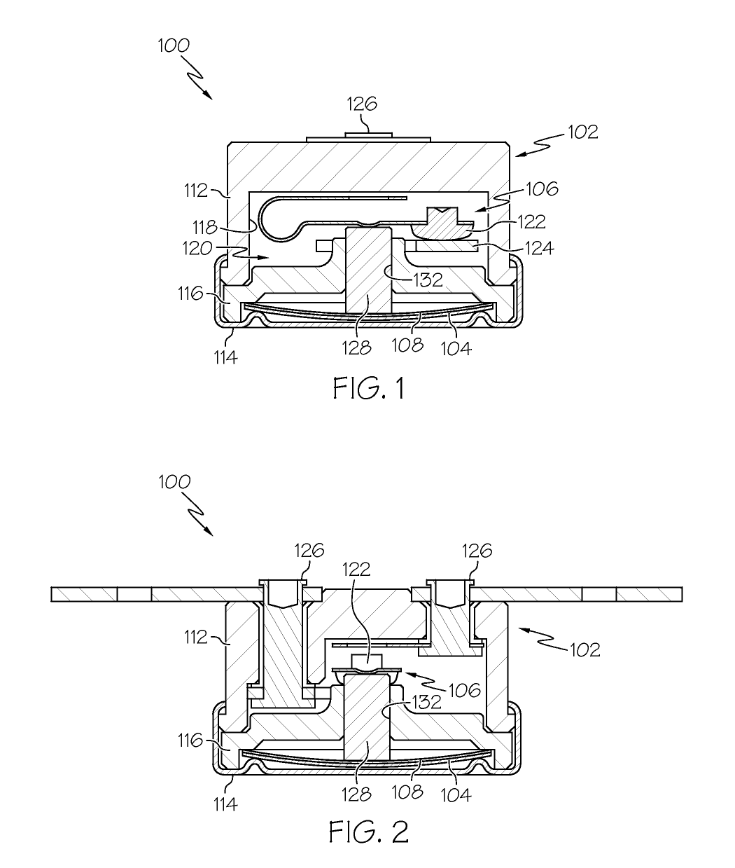

Referring to FIG. 1, a cross section view of one exemplary embodiment of a one-shot thermostat is depicted. The one-shot thermostat 100 includes a housing 102, a temperature sensitive element 104, a switch 106, and a spring element 108. The housing 102 may be variously configured and implemented, but in the depicted embodiment the housing 102 includes a base 112, an end cap 114, and a retainer 116. The base 112 includes an inner surface 118 that defines an inner volume 120. The end cap 114 is coupled to the base 112 and encloses the inner volume 120. The retainer 116 is disposed between the base 112 and the end cap 114 and, together with the end cap 114, retains the temperature sensitive element 104 within the housing 102.

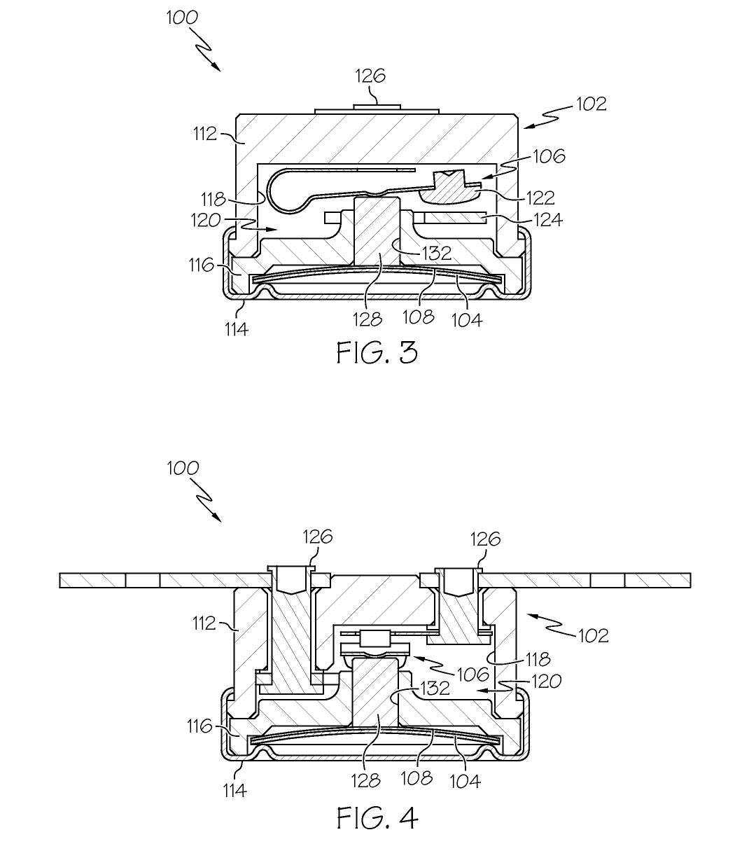

The temperature sensitive element 104 is responsive to temperature variations to selectively move between at least a first position and a second position. The temperature sensitive element 104 may be variously configured to implement this functionality, but in the depicted embodiment it is a bimetallic element. The bimetallic element 104 will move (or “snap”) from the first position, which is the position depicted in FIGS. 1 and 2, to the second position, which is the position depicted in FIGS. 3 and 4, when the temperature of the bimetallic element 104 increases above a first predetermined temperature. The bimetallic element 104 will then move from the second position back to the first position when its temperature decreases below a second predetermined temperature. As is generally known, the specific temperatures at which the bimetallic element 104 switches from the first position to the second position and from the second position back to the first position, may vary and may be determined by material selection and shape. In the depicted embodiment, the bimetallic element 104 is disc-shaped.

The switch 106 is disposed within the housing inner volume 120, and is movable between a first switch position and a second switch position. Although the configuration of the switch 106 may vary, in the depicted embodiment it includes a movable contact 122 and a fixed contact 124. The switch 106 is additionally configured, at least in the depicted embodiment, such that when the switch 106 is in the first switch position, which is the position depicted in FIGS. 1 and 2, the movable contact 122 is electrically connected to the fixed contact 124. Conversely, when the switch 106 is in the second position, which is the position depicted in FIGS. 3 and 4, the movable contact 122 is electrically isolated from the fixed contact 124. It will be appreciated that this is merely exemplary of one embodiment, and that in other embodiments the movable contact 122 could be electrically isolated from the fixed contact 124 when the switch is in the second position, and electrically connected to the fixed contact 124 when the switch is in the first position. The movable contact 122 and the fixed contact 124 are both coupled to the housing 102, and more particularly to the base 112, via suitable fasteners (not illustrated) such as, for example, screws or rivets. The movable contact 122 and fixed contact 124 are also electrically connected to one or more terminals 126 that are used to electrically connect the thermostat 100 to various other external systems.

The spring element 108 is mounted within the housing 102, between the temperature sensitive element 104 and the switch 106, and is in contact with the temperature sensitive element 104. The spring element 108 is configured to supply a retainer force to the switch 106 when the temperature sensitive element 104 moves from the first position to the second position. The retainer force retains the switch 106 in the second switch position even if (or when) the temperature sensitive element 104 moves from the second position back to the first position.

It will be appreciated that the spring element 108 may be variously configured and implemented to carry out the above-described function, but in the depicted embodiment the spring element 108 comprises a spring disc that is movable between a non-retaining position, which is the position depicted in FIGS. 1 and 2, and a retaining position, which is the position depicted in FIGS. 3 and 4. In particular, the spring element 108 is configured to move from the non-retaining position to the retaining position when the temperature sensitive element 104 moves from the first position (FIGS. 1 and 2) to the second position (FIGS. 3 and 4). The spring element 108 is additionally configured to remain in the retaining position even if (or when) the temperature sensitive element 104 moves from the second position back to the first position.

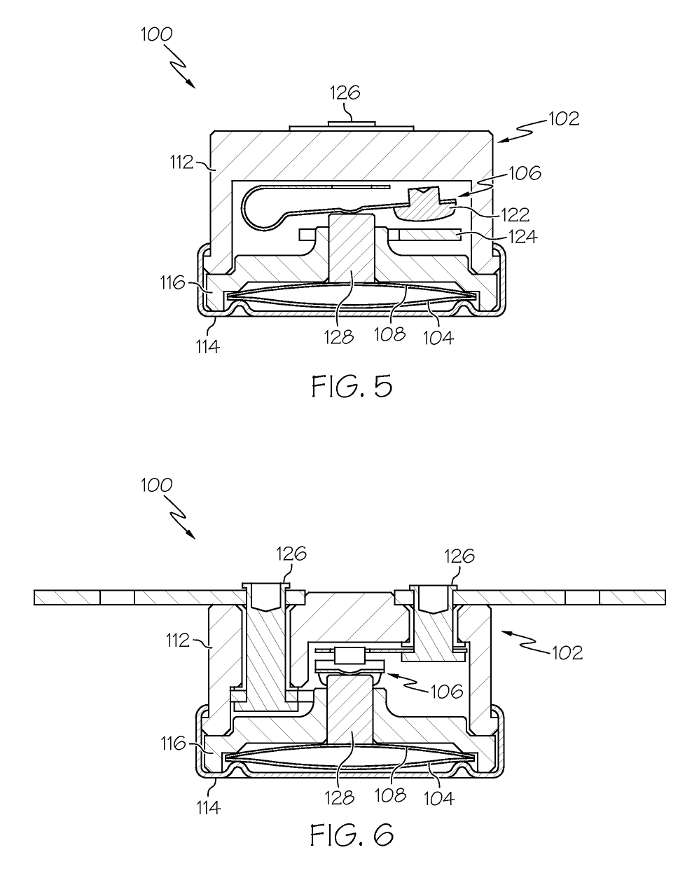

When the spring element is in the non-retaining position, it does not supply the retainer force to the switch 106. Conversely, when it is in the retaining position, the spring element 108 supplies the retainer force to the switch 106. As FIGS. 5 and 6 depict, the spring element 108 will continue to supply the retainer force to the switch 106 even if (or when) the temperature sensitive element 104 moves from the second position back to the first position. This is because, as was just noted, the spring element 108 remains in the retaining position even if (or when) the temperature sensitive element 104 moves from the second position back to the first position.

It will be appreciated that the thermostat 100 could be configured such that the spring element 108 directly contacts, and thus directly moves and supplies the retainer force to, the switch 106. However, in the depicted embodiment, a transfer pin 128 is disposed between the switch 106 and the spring element 108. The transfer pin 128 extends through a transfer pin opening 132 that is formed through the retainer 116 and is configured to selectively move the switch 106 from the first switch position to the second switch position. More specifically, the transfer pin 128, upon movement of the spring element 108 from the non-retaining position to the retaining position, supplies the retainer force to the switch 106, which moves the switch 106 from the first switch position to the second switch position and retains the switch 106 in the second switch position.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A one-shot thermostat, comprising:
a housing;
a temperature sensitive element mounted within the housing and responsive to temperature to selectively move (i) from a first position to a second position when the temperature of the temperature sensitive element increases above a first predetermined temperature and (ii) from the second position back to the first position when the temperature of the temperature sensitive element decreases below a second predetermined temperature;
a switch mounted within the housing and movable between a first switch position and a second switch position, the switch configured, upon movement of the temperature sensitive element from the first position to the second position, to move from the first switch position to the second switch position; and
a spring element mounted within the housing and in contact with the temperature sensitive element, the spring element disposed between the temperature sensitive element and the switch and configured to supply a retainer force to the switch when the temperature sensitive element moves from the first position to the second position, the retainer force retaining the switch in the second switch position when the temperature sensitive element moves from the second position back to the first position.

2. The one-shot thermostat of claim 1, wherein the spring element is configured to (i) move from a non-retaining position to a retaining position, and thereby supply the retainer force to the switch, when the temperature sensitive element moves from the first position to the second position and (ii) remain in the retaining position when the temperature sensitive element moves from the second position back to the first position.

3. The one-shot thermostat of claim 2, wherein the spring element comprises a spring disc.

4. The one-shot thermostat of claim 1, further comprising:
a transfer pin disposed between the switch and the spring element, the transfer pin configured, upon movement of the temperature sensitive element from the first position to the second position, to move the switch from the first switch position to the second switch position.

5. The one-shot thermostat of claim 1, wherein:
the switch comprises a fixed contact and a movable contact;
the movable contact is electrically connected to the fixed contact when the switch is in the first switch position; and
the movable contact is electrically isolated from the fixed contact when the switch is in the second switch position.

6. The one-shot thermostat of claim 1, wherein the spring element comprises a spring disc.

7. The one-shot thermostat of claim 1, wherein the housing comprises:
a base;
an end cap coupled to the base; and
a retainer coupled between the base and the end cap, the retainer retaining the temperature sensitive element and the spring element within the housing.

8. The thermostat of claim 7, wherein:
the retainer includes a transfer pin opening; and
the transfer pin extends through the transfer pin opening.

9. The one-shot thermostat of claim 1, wherein the temperature sensitive element comprises a bimetallic element.

10. The one-shot thermostat of claim 6, wherein the bimetallic element comprises a bimetal disc.

11. A one-shot thermostat, comprising:
a housing;
a switch disposed within the housing and movable between a first switch position and a second switch position;
a temperature sensitive element disposed within the housing and responsive to temperature, the temperature sensitive element configured to (i) move from a first position to a second position when the temperature of the temperature sensitive element increases above a first predetermined temperature and (ii) move from the second position back to the first position when the temperature of the temperature sensitive element decreases below a second predetermined temperature;
a spring disc mounted within the housing in contact with the temperature sensitive element, and disposed between the temperature sensitive element and the switch, the spring disc configured to supply a retainer force to the switch when the temperature sensitive element moves from the first position to the second position, the retainer force retaining the switch in the second switch position when the temperature sensitive element moves from the second position back to the first position; and
a transfer pin disposed between the switch and the spring disc, the transfer pin configured, upon movement of the temperature sensitive element from the first position to the second position, to move the switch from the first switch position to the second switch position.

12. The one-shot thermostat of claim 11, wherein the spring disc is configured to (i) move from a non-retaining position to a retaining position, and thereby supply the retainer force to the switch, when the temperature sensitive element moves from the first position to the second position and (ii) remain in the retaining position when the temperature sensitive element moves from the second position back to the first position.

13. The one-shot thermostat of claim 11, wherein:
the switch comprises a fixed contact and a movable contact;
the movable contact is electrically connected to the fixed contact when the switch is in the first switch position; and
the movable contact is electrically isolated from the fixed contact when the switch is in the second switch position.

14. The one-shot thermostat of claim 11, wherein the spring element comprises a spring disc.

15. The one-shot thermostat of claim 11, wherein the housing comprises:
a base;
an end cap coupled to the base; and
a retainer coupled between the base and the end cap, the retainer retaining the temperature sensitive element and the spring element within the housing.

16. The one-shot thermostat of claim 15, wherein:
the retainer includes a transfer pin opening; and
the transfer pin extends through the transfer pin opening.

17. The one-shot thermostat of claim 11, wherein the temperature sensitive element comprises a bimetallic element.

18. The one-shot thermostat of claim 17, wherein the bimetallic element comprises a bimetal disc.

19. A one-shot thermostat, comprising:
a housing;
a switch disposed within the housing and movable between a first switch position and a second switch position;
a bimetallic disc disposed within the housing and responsive to temperature, the bimetallic disc configured to (i) move from a first position to a second position when the temperature of the bimetallic disc increases above a first predetermined temperature and (ii) move from the second position back to the first position when the temperature of the bimetallic disc decreases below a second predetermined temperature;
a transfer pin disposed adjacent the switch and configured, upon movement of the bimetallic disc from the first position to the second position, to move the switch from the first switch position to the second switch position; and
a spring disc mounted within the housing in contact with the temperature sensitive element, and disposed between the temperature sensitive element and the transfer pin, the spring disc configured to (i) move from a non-retaining position to a retaining position when the bimetallic disc moves from the first position to the second position and (ii) remain in the retaining position when the temperature sensitive element moves from the second position back to the first position,
wherein the spring disc supplies a retainer force to the transfer pin that retains the switch in the second switch position when the bimetallic disc moves from the second position back to the first position.

20. The one-shot thermostat of claim 19, wherein:
the switch comprises a fixed contact and a movable contact;
the movable contact is electrically connected to the fixed contact when the switch is in the first switch position; and
the movable contact is electrically isolated from the fixed contact when the switch is in the second switch position.
